(19) United States
(12) Patent Application Publication
(10) Pub. No.: US 2018/0276445 A1
(43) Pub. Date: Sep. 27, 2018

(54) METHOD, ELECTRONIC DEVICE, AND DISPLAY PANEL FOR FINGERPRINT DETECTION

(71) Applicant: Lenovo (Beijing) Co., Ltd., Beijing (CN)

(72) Inventors: Hailong WU, Beijing (CN); Nan LIN, Beijing (CN); Minggui QIAN, Beijing (CN)

(21) Appl. No.: 15/928,578

(22) Filed: Mar. 22, 2018

(30) Foreign Application Priority Data
Mar. 22, 2017 (CN) 201710173474.X

(51) Int. Cl. G06K 9/00; G06F 3/041

(52) U.S. Cl. CPC G06K 9/00013; G06F 3/0412

(57) ABSTRACT

Method, electronic device, and display panel for fingerprint detection are provided. A control instruction for collecting a fingerprint is obtained. The control instruction is executed to control at least one display pixel cell of a display panel to be under a fingerprint identification mode. The at least one display pixel cell of the display panel corresponds to a fingerprint collection region. The fingerprint collection region includes a partial region of the display panel. The fingerprint information in the fingerprint collection region is obtained by the at least one display pixel cell under the fingerprint identification mode.

### CROSS-REFERENCES TO RELATED APPLICATIONS

This application claims the priority of Chinese Patent Application No. 201710173474.X, filed on Mar. 22, 2017, the entire content of which is incorporated herein by reference.

### FIELD OF THE DISCLOSURE

The present disclosure relates to the field of display apparatus technologies and, more particularly, relates to method, electronic device and display panel for fingerprint detection.

### BACKGROUND

With a continuous advance of science and technology, electronic devices with display functions are widely used and have brought a great convenience, e.g., as an indispensable and important tool, to people's daily life. A display module is a main component for an electronic device to realize the display function. For example, a liquid crystal display (LCD) penal is one of the commonly-used display modules of current electronic devices.

In order to ensure the safety of users' personal information, the existing electronic devices are generally integrated with fingerprint detection modules. However, conventional fingerprint detection module and the display module are two separate modules. The fingerprint detection module and the display module perform independent functions and have no interaction with each other.

### BRIEF SUMMARY OF THE DISCLOSURE

One aspect of the present disclosure provides a method for fingerprint detection. The method may include: obtaining a control instruction for collecting a fingerprint; executing the control instruction to control at least one display pixel cell of a display panel, corresponding to a fingerprint collection region, to be under a fingerprint identification mode; and obtaining fingerprint information in the fingerprint collection region by the at least one display pixel cell under the fingerprint identification mode. The fingerprint collection region includes a partial region of the display panel.

Another aspect of the present disclosure provides an electronic device for fingerprint detection. The electronic device may include: a display panel including a plurality of display pixel cells in array; a control circuit configured to obtain a control instruction for collecting fingerprint, and to execute the control instruction to: control at least one of the display pixel cells, corresponding to a fingerprint collection region, to be under a fingerprint identification mode; and obtain fingerprint information of a finger in the fingerprint collection region by the at least one display pixel cell under the fingerprint identification mode. The fingerprint collection region may include a partial region of the display panel.

Still another aspect of the present disclosure provides a display panel of an electronic device. The display panel may include: a plurality of display pixel cells, arranged in a display array, the display array including a display output region; and connecting ports, electrically connected to a control circuit and the plurality of display pixel cells. The control circuit, via the connecting ports, provides a fingerprint detection signal to at least one display pixel cell of a fingerprint collection region, such that the at least one display pixel cell is under a fingerprint identification mode, the fingerprint collection region being a partial region of the display panel.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various embodiments and are not intended to limit the scope of the present disclosure.

FIG. 1 shows a flow diagram of a method for fingerprint detection consistent with some embodiments of the present disclosure;

FIG. 2 shows a flow diagram for executing a control instruction to perform a fingerprint identification consistent with some embodiments of the present disclosure;

FIG. 3 shows a flow diagram of another method for executing a control instruction to perform a fingerprint identification consistent with some embodiments of the present disclosure;

FIG. 4 shows a schematic diagram of an electronic device consistent with some embodiments of the present disclosure;

FIG. 5 is a schematic diagram of a display panel consistent with some embodiments of the present disclosure;

FIG. 6 is a schematic diagram of another display panel consistent with some embodiments of the present disclosure;

FIG. 7 is a schematic diagram of a display panel applying the method for fingerprint detection consistent with some embodiments of the present disclosure; and

FIGS. 8A and 8B are schematic diagrams of a display panel applying another method for fingerprint detection consistent with some embodiments of the present disclosure.

### DETAILED DESCRIPTION

Reference will now be made in detail to embodiments of the present disclosure, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present disclosure. Based on the embodiments, persons of ordinary skill in the art may derive other embodiments consistent with the present disclosure, all of which are within the scope of the present disclosure.

Other embodiments of the disclosure will be apparent to those skilled in the art from consideration of the specification and practice of the disclosure provided herein. It is intended that the specification and examples be considered as for example only, with a true scope and spirit of the disclosure being indicated by the claims.

The present disclosure provides a method, an electronic device, and a display panel for fingerprint detection. At least one display pixel cell of the display panel may be configured for fingerprint detection. Fingerprint information is obtained by the at least one display pixel cell under a fingerprint identification mode. Compared to the existing technical solutions in which the fingerprint detection module and the display panel are two separate components, the present disclosure provides technical solutions by integrating fingerprint detection function with at least one display pixel cell, without using a separately configured fingerprint detection module. The degree of integration is therefore improved.

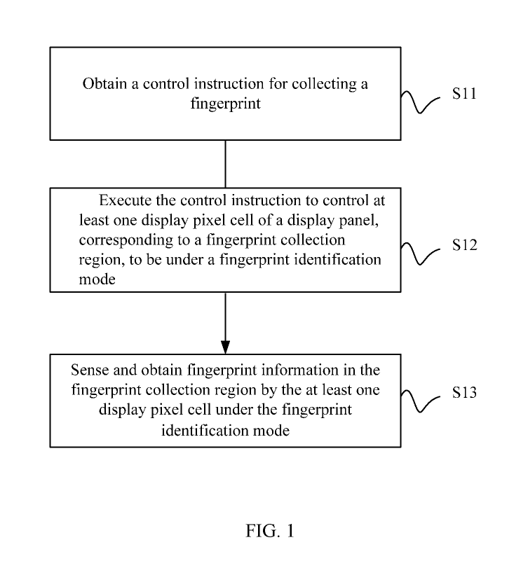

FIG. 1 shows a flow diagram of a method for fingerprint detection consistent with some embodiments of the present disclosure.

In S11: Obtaining a control instruction for collecting a fingerprint.

An electronic device may include a display panel. The display panel may include a touch display. The touch display may be used to input control instruction through touch keys on the touch display. Alternatively, the control instruction may be inputted through mechanical keys configured with the touch displays. Manners of inputting a control instruction are not limited to the examples identified above.

In S12: Executing the control instruction to control at least one display pixel cell of a display panel, corresponding to a fingerprint collection region, to be under a fingerprint identification mode.

The display panel may include a plurality of display pixel cells, and the plurality of display pixel cells may be formed as a display array. The display array may act as a display output region of the display panel, and the fingerprint collection region may be a partial region or an entire region of the display panel.

Prior to obtaining the control instruction, all of the display pixel cells may be under a display mode. Upon receiving the control instruction, the control instruction is executed to control the at least one display pixel cell of the display panel, corresponding to the fingerprint collection region, to be under the fingerprint identification mode. The at least one display pixel cell may include a part of or all of the display pixel cells in the fingerprint collection region.

Consistent with some embodiments of the present disclosure, the display panel may be a liquid crystal display (LCD) panel. Each of the display pixel cells may include a plurality of sub-pixels for displaying different colors, and each of the sub-pixels may include a transparent pixel electrode. In some instances, each of the display pixel cells may include three sub-pixels, including a red sub-pixel R, a green sub-pixel G, and a blue sub-pixel B. In this scenario, the display panel adopts a RGB display driving method. In other instances, however, each of the display pixel cells may further include a white sub-pixel W, and the display panel accordingly adopts a RGBW display driving method instead.

Executing the control instruction to control the at least one display pixel cell, corresponding to the fingerprint collection region, to be under the fingerprint identification mode, as described above, may include: controlling a first pixel electrode of the at least one display pixel cell as a transmitting end of a fingerprint collection, and controlling a second pixel electrode of the at least one display pixel cell as a receiving end of the fingerprint collection.

For example, in any display pixel cell, the first pixel electrode may include a pixel electrode of any sub-pixel in the display pixel cell, while the second pixel electrode may include a pixel electrode of another sub-pixel in the same display pixel cell.

In S13: Obtaining fingerprint information of a finger in the fingerprint collection region by the at least one display pixel cell under the fingerprint identification mode.

In some embodiments, obtaining the fingerprint information in the fingerprint collection region by the at least one display pixel cell under the fingerprint identification mode, may include: upon driving the display panel to complete displaying an image frame and before driving the display panel to start displaying a next image frame, providing a driving signal of a fingerprint scanning to the transmitting end, and performing a fingerprint identification according to a detection signal outputted from the receiving end. In this manner, the fingerprint information in the fingerprint collection region is obtained.

The method for fingerprint detection provided by the present disclosure, after obtaining and executing the control instruction, may include: controlling the at least one display pixel cell of the display panel corresponding to the fingerprint collection region to be under fingerprint identification mode. The at least one display pixel cell is further configured to perform fingerprint identification. Accordingly, there is no need to individually/separately configure a fingerprint detection module in the display panel and there is no need to form holes in the display panel for mounting the fingerprint detection module. Production cost may be reduced. Meanwhile, damages to mechanical strength of the display panel due to punching holes may be avoided.

In general, a height difference of a valley and a ridge of a fingerprint ranges from about 100 μm to about 400 μm, and a pitch of two adjacent ridge lines ranges from about 300 μm to about 500 μm. Based on these ranges of the height difference and the pitch, in order to realize the fingerprint identification, a pitch of fingerprint detection electrodes may be designed below 50 μm.

The pitch between the pixel electrodes of the display panel is generally less than 50 μm, which meets the requirement for a fingerprint detection electrode. Regarding a 5.5″ full high definition (FHD) display panel, for example, a width of the pixel electrode is approximately 22 μm. In order to display an image frame, when a display panel is driven to proceed with displaying, a driving signal of display scanning is required to provide to the display pixel cells of each row, such that a display data signal is provided to each pixel electrode respectively to complete the displaying of one image frame. A time interval is between the display data signals of two adjacent image frames. During the display driving time interval of two adjacent image frames, the at least one display pixel cell is controlled to be under fingerprint identification mode. And the at least one display pixel cell is further configured as a fingerprint detection electrode to obtain the fingerprint information of a finger placed in the fingerprint collection region. The fingerprint detection function provided by the present disclosure is established, in addition to the normal image display. Thus, the individually installed fingerprint detection module may be omitted.

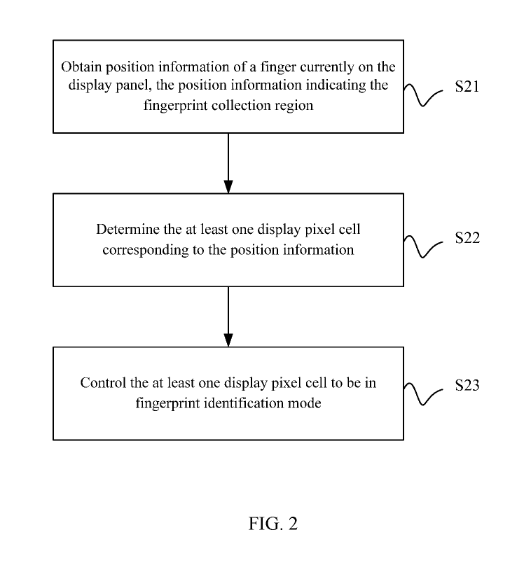

Consistent with some embodiments of the present disclosure, the fingerprint collection region may include the at least one display pixel cell of the display panel. The fingerprint collection region may be determined according to a touch position of a finger. In this case, as illustrated in FIG. 2, the control instruction may be executed by controlling the at least one display pixel cell of the display panel, corresponding to the fingerprint collection region, to be under the fingerprint identification mode. More specifically, FIG. 2 shows a flow diagram for executing the control instruction to perform the fingerprint identification consistent with some embodiments of the present disclosure.

In S21: Obtaining position information of a finger currently on the display panel, the position information indicating the fingerprint collection region.

The display panel may include a liquid crystal display touch panel configured to detect and provide the position information of a finger currently on the display panel. Upon executing the control instruction, by detecting the position of the finger currently on the display panel, the position information of the finger on the display panel may be obtained. Further through the position information, the fingerprint collection region may be determined. A region where the display panel obtains the position information of the finger may be the fingerprint collection region.

In S22: Determining the at least one display pixel cell corresponding to the position information.

In a direction that is perpendicular to the display panel, the at least one display pixel cell is located in the fingerprint collection region.

In S23: Controlling the at least one display pixel cell to be under fingerprint identification mode.

Further, the at least one display pixel cell may be configured to perform the fingerprint identification as stated above.

Consistent with some embodiments, in the method as illustrated in FIG. 2, the fingerprint collection region may include a partial region of the display array in the display panel, and the fingerprint collection region may not be a fixed area of the display panel. Upon receiving and executing the control instruction, the fingerprint collection region may be determined according to the position of the finger.

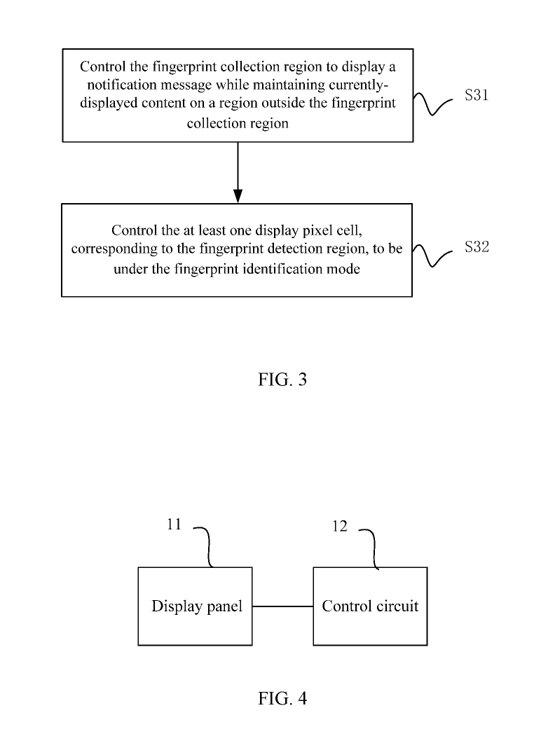

However, in some examples, the fingerprint collection region may include a fixed area corresponding to a partial region of the display array in the display panel. That is, the position of the fingerprint collection may be fixed. Meanwhile, the at least one display pixel cell, corresponding to the fingerprint collection region, is controlled to be under the fingerprint identification mode. FIG. 3 shows a flow diagram of another method for executing the control instruction to perform the fingerprint identification consistent with some embodiments of the present disclosure.

In S31: Controlling the fingerprint collection region to display a notification message, while maintaining currently-displayed content on a region outside the fingerprint collection region.

Through the notification message, the position of the fingerprint collection region in the display panel may be displayed to facilitate a user to locate the position for fingerprint identification.

The position of the fingerprint collection region in the display array may be determined according to a need. For example, if the electronic device is a mobile phone, the fingerprint collection region may correspond to a bottom portion of the display panel so as to facilitate the user's thumb to perform the fingerprint identification in holding the mobile phone by one hand. When the user holds the mobile phone by his/her right hand, the right thumb can easily touch the fingerprint collection region for fingerprint identification.

In S32: Controlling the at least one display pixel cell, corresponding to the fingerprint collection region, to be under the fingerprint identification mode.

One manner to display the notification message may be, through a partial region of the display pixel cells in the fingerprint collection region, to notify the user of the position of the fingerprint collection region. Afterwards, the display of the notification message may be terminated, and the at least one display pixel cell, corresponding to the fingerprint detection, is controlled to be under the fingerprint identification mode. In this manner, the display pixel cells for displaying the notification message in S31 may be also used for fingerprint identification in S32.

Another manner to display the notification message may be, also through a partial region of the display pixel cells in the fingerprint collection region, to display preset image information to notify the user of the position of the fingerprint collection region. Upon a partial region of the display pixel cells displaying the preset image information, at least one display pixel cell of another portion of the display pixel cells is controlled to be under fingerprint identification mode. In this manner, when the at least one display pixel cell performs the fingerprint identification under the fingerprint identification mode, the display pixel cells for displaying the notification message may still maintain displaying the notification message.

In the second manner stated above, all the sub-pixels of a first color in the fingerprint collection region may be configured to display the notification message, while the sub-pixels of the other colors may be configured to perform the fingerprint identification. For example, all the green sub-pixels in the fingerprint collection region may be configured to emit green light to highlight the fingerprint collection region in green to notify the user of the position of the fingerprint collection region. And all the red sub-pixels and the blue sub-pixels may be configured such that the sub-pixels of one color may be selected as the transmitting ends and the sub-pixels of the other color may be the receiving ends.

Consistent with some embodiments of the present disclosure, the fingerprint collection region may include a partial region of the display output region of the display panel, or may include the entire display output region. If the fingerprint collection region includes the entire display output region of the display panel, upon executing the control instruction, all the display pixel cells of the display panel may be under the fingerprint identification mode.

One display cycle of the display panel may include a time duration to drive all the display pixel cells to display an image frame. Generally speaking, a time interval lies between two adjacent display cycles. In some embodiments, the method for fingerprint detection provided by the present disclosure may conduct the fingerprint identification in a time interval between two adjacent display cycles. In fingerprint detection, the at least one display pixel cell in the fingerprint collection region may be controlled to be under the fingerprint identification mode. Further, the at least one display pixel cell is configured as an electrode for fingerprint detection to obtain the fingerprint information. Accordingly, there is no need to individually configure a fingerprint detection module in the display panel and there is no need to form holes in the display panel for mounting the fingerprint detection module. Production cost may be reduced. Meanwhile, damages to mechanical strength of the display panel due to punching holes may be avoided.

Based on the above-mentioned method for fingerprint detection, the present disclosure further provides an electronic device, as shown in FIG. 4. More specifically, FIG. 4 shows a schematic diagram of an electronic device consistent with some embodiments of the present disclosure. The electronic device may include: a display panel 11 and a control circuit 12. The display panel 11 may include a plurality of display pixel cells in array as a display array. The control circuit 12 may be configured to obtain a control instruction for collecting fingerprint and to execute the control instruction to control at least one of the display pixel cells, corresponding to a fingerprint collection region, to be under a fingerprint identification mode. Through the at least one display pixel cell under the fingerprint identification mode, fingerprint information of a finger in the fingerprint collection region may be obtained. The fingerprint collection region may include a partial region of the display panel.

The control circuit 12 may be electrically connected to the display pixel cells of the display panel 11. The plurality of display pixel cells may be arranged in array. And the display array may include a display output region of the display panel. The display panel 11 may include a frame region surrounding the display output region, and the control circuit 12 may be disposed in the frame region, or may be provided in a main circuit board of the electronic device. The control circuit 12 may be electrically connected to the display pixel cells of the display panel 11 via a flexible printed circuit (FPC).

When the control instruction is executed, in order to control the at least one display pixel cell in the display panel 11, corresponding to the fingerprint detection region, to be under the fingerprint identification mode, the control circuit 12 may be configured to control a first pixel electrode of the at least one display pixel cell as a transmitting end of fingerprint detection, and control a second pixel electrode of the at least one display pixel cell as a receiving end of fingerprint detection.

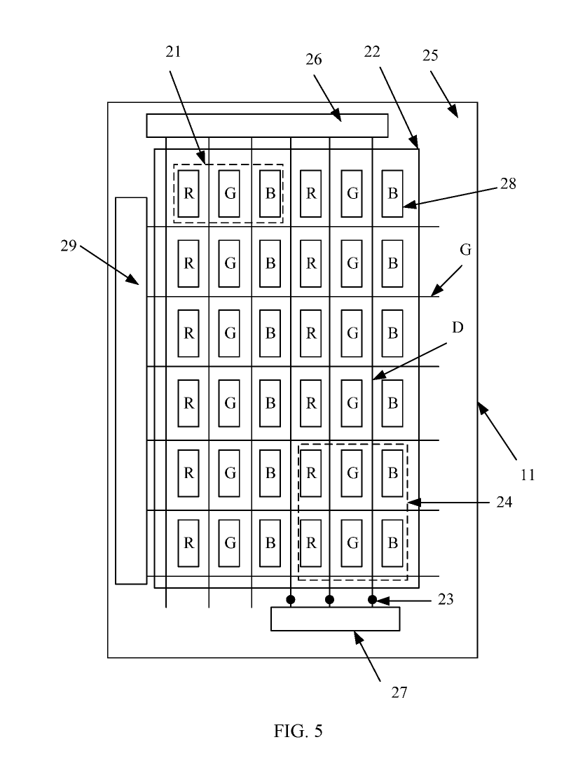

The control circuit 12 may include a display driver chip 26 and a fingerprint identification chip 27 (shown in FIG. 5). The display driver chip 26 may be electrically connected to the display pixel cells of the display panel 11. And the fingerprint identification chip 27 may be electrically connected to the at least one display pixel cell under the fingerprint identification mode. When the control circuit 12 executes the control instruction, in order to control the at least one display pixel cell of the display panel 11, corresponding to the fingerprint collection region, to be under the fingerprint identification mode, upon the display driver chip 26 driving the display panel to complete displaying an image frame and prior to the display driver chip 26 driving the display panel to start displaying a next image frame, the fingerprint identification chip 27 may be configured to provide a driving signal of fingerprint scanning to the transmitting end, and to perform fingerprint identification according to a detection signal outputted from the receiving end.

In some embodiments, to control the at least one display pixel cell of the display panel 11, corresponding to the fingerprint region, to be under fingerprint identification mode, the control circuit 12 may be configured to obtain the position information of the finger currently on the display panel, and the position information may indicate the fingerprint collection region. At least one of the display pixel cells, corresponding to the position information, may be determined. Further, the at least one display pixel cell may be controlled to be under the fingerprint identification mode. In other embodiments, the control circuit 12 may be configured to control the fingerprint collection region to display a notification message while maintaining currently-displayed content on a region outside the fingerprint collection region. The position of the fingerprint detection in the display panel may be displayed through the notification message. The at least one display pixel cell, corresponding to the fingerprint collection region, may be controlled to be under the fingerprint identification mode.

The electronic device provided by the present disclosure realizes the above-mentioned method for fingerprint detection. In addition, the at least one display pixel cell of the display panel, corresponding to fingerprint collection region, may be configured for fingerprint identification. Through the at least display pixel cell of the display panel under fingerprint identification mode, the fingerprint information is obtained. Accordingly, there is no need to individually configure a fingerprint detection module in the display panel, and there is also need to form holes in the display panel for mounting the fingerprint detection module. Production cost may be reduced. Meanwhile, damages to mechanical strength of the display panel due to punching holes may be avoided.

Based on the method for fingerprint detection and the related electronic device, another aspect of the present disclosure further provides a display panel of the electronic device applying the methods as described above. FIG. 5 is a schematic diagram of a display panel consistent with some embodiments of the present disclosure. A display panel 11 as illustrated in FIG. 5 may include: a plurality of display pixel cells 21, connecting ports 23. The plurality of display pixel cells 21 may be arranged in array. The display array may include a display output region 22 of the display panel. The connecting ports 23 may be electrically connected to a control circuit and the plurality of display pixel cells 21. The control circuit, via the connecting ports 23, provides a fingerprint detection signal to at least one display pixel cell of a fingerprint collection region 24, such that the at least one display pixel cell is under a fingerprint identification mode. The fingerprint collection region 24 may be a partial region of display output region 22 as shown in FIG. 5.

The display panel 11 may further include a frame region 25 surrounding the display output region 22. The control circuit may include the display driver chip 26 and the fingerprint identification chip 27 as shown. In some instances, the display driver chip 26 and the fingerprint identification chip 27 may be arranged in the frame region 25 of the display panel 11. Alternatively, the display driver chip 26 and the fingerprint identification chip 27 may also be allocated in a main circuit board, and the control circuit is connected to the display pixel cells 21 through an FPC.

Each of the display pixel cells may include a plurality of sub-pixels 28. For an example as shown in FIG. 5, each display pixel cell 21 may include a red sub-pixel R, a green sub-pixel G, and a blue sub-pixel B. All the sub-pixels may be arranged in array. Each sub-pixel 28 may include a thin-film transistor (not shown in FIG. 5). The thin-film transistor may include a gate electrode, a source electrode and a drain electrode, respectively. A pixel electrode of a sub-pixel 28 may be electrically connected to a drain electrode of the thin-film transistor.

The sub-pixels 28 in one row may correspond to a single gate line G. More specifically, gate electrodes of the sub-pixels 28 may be connected to the corresponding gate line G, and the gate line G may be further connected to a gate scan circuit 29. The sub-pixels 28 in one column may correspond to a single data line D. More specifically, source electrodes of the sub-pixels 28 may be connected to the corresponding data line D, and the data line D may be further connected to the display driver chip 26.

In displaying an image frame, the gate scan circuit 29 may be configured to scan the display pixel cells 21 in each row and provide a scan driving signal for the display pixel cells 21 in each row to control the conduction of the thin-film transistors in each row. When the thin-film transistors are switched on, the display driver chip 26 may be configured to provide the pixel electrodes of the corresponding sub-pixels 28 with a display data signal so as to display an image frame. Upon driving the display panel to complete displaying an image frame and before driving the display panel to start displaying a next image frame, the fingerprint collection is performed. By the gate scan circuit 29 configured to scan the display pixel cells 21 in each row, corresponding to the fingerprint collection region 24, the fingerprint identification chip 27 may be configured to provide a driving signal of fingerprint scanning to the first pixel electrode of the corresponding display pixel cell 21, and according to a detection signal outputted from the second pixel electrode of the corresponding display pixel cell 21, to perform the fingerprint identification.

In one example shown in FIG. 5, the fingerprint collection region 24 may be a partial region of the display output region 22, which is a fixed region. The fingerprint identification chip 27 may be connected to the pixel electrodes of the display pixel cells 21 corresponding to the fingerprint collection region 24. In this case, the pixel electrodes may be connected to the fingerprint identification chip 27 through the existing data lines D. Therefore, there is no extra cost for wiring. In some instances, the fingerprint collection region 24 may be dynamically determined according to the position information of the finger. Therefore, under this scenario, the fingerprint collection region 24 may include the whole display output region 22.

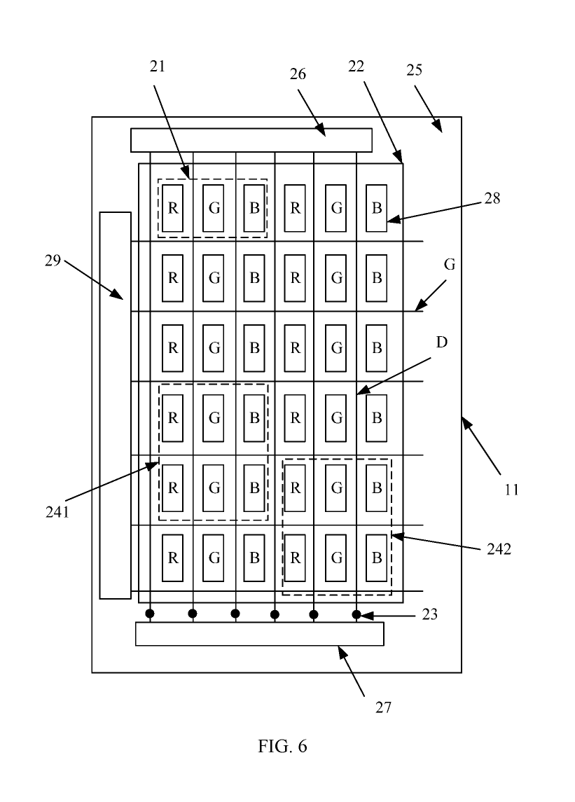

FIG. 6 is a schematic diagram of another display panel consistent with some embodiments of the present disclosure. As depicted in FIG. 6, all of the data lines D may include the connecting ports 23, and the fingerprint identification chip 27 may be connected to each of the connecting ports 23.

The display panel 11 as shown in FIG. 6 may be configured to first obtain the position information of the finger currently on the display panel. According to the position information, a position of the fingerprint collection region 24 may be determined so as to control the at least one display pixel cell 21, corresponding to the fingerprint collection region 24, to be under fingerprint identification mode, and further obtain the fingerprint information.

For example, if a finger touches a region 241, the region 241 may be specified as the fingerprint collection region according to the position information. On the other hand, another region 242 may be also specified as the fingerprint collection region if a finger touches the region 242. As such, the fingerprint collection region may be determined according to the position of the finger to facilitate an easy use.

In some examples, a whole of the display output region 22 of the display panel 11 may be specified as the fingerprint collection region 24 to enable all the display pixel cells 21 to be under fingerprint identification mode and obtain the fingerprint information. Among the display output region 22, a fixed region 241, for example, may be specified as the fingerprint collection region. The fingerprint collection region may be determined in any position of the display panel according to a need.

The display panel as provided in the above embodiments may be applied to the electronic device and the method for fingerprint detection. In fingerprint collection, at least one display pixel cell in the fingerprint collection region may be controlled to be under fingerprint identification mode. Further, the at least one display pixel cell may be configured as an electrode for fingerprint detection to obtain the fingerprint information. Accordingly, there is no need to individually configure a fingerprint detection module in the display panel and there is no need to form holes in the display panel for mounting the fingerprint detection module. Production cost may be reduced. Meanwhile, damages to mechanical strength of the display panel due to punching holes may be avoided.

When the display panel 11 is applied, the at least one display pixel cell of the display panel, corresponding to the fingerprint collection region, is controlled to be under fingerprint identification mode. The fingerprint collection region may be determined by the position information of the finger so as to enable at least one display pixel cell in the fingerprint collection region to be under fingerprint identification mode.

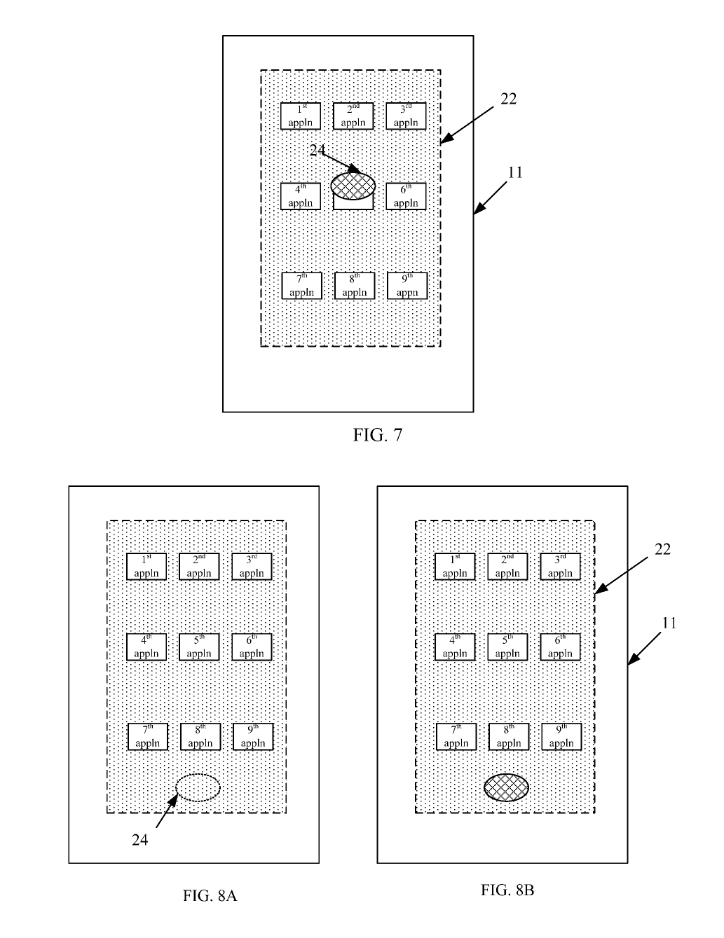

FIG. 7 is a schematic diagram of a display panel applying the method for fingerprint detection consistent with some embodiments of the present disclosure. As shown, upon a finger touching the display output region 22 of the display 11, the fingerprint collection region 24 may be determined according to the position of the finger. In this case, the fingerprint collection region 24 may include a partial region where the finger touches the display panel.

As shown in FIG. 7, when a finger touches the display panel 11, at least one display pixel cell in the fingerprint collection region 24 may be controlled to be under the fingerprint identification mode. The at least one display pixel cell may be configured to obtain the fingerprint information. And display pixel cells in a region outside the fingerprint collection region 24 may be configured to maintain a previous display data. For an example as shown in FIG. 7, the display pixel cells in the fingerprint collection region 24 do not display an image but instead perform the fingerprint collection after a finger touches the fingerprint collection region 24 (shown in grid lines). On the other hand, the display pixel cells outside the fingerprint collection region 24 maintain the previous display data respectively, while the displayed image remains unchanged. Because the finger now covers the fingerprint collection region 24 in operation, it does not affect a user's visual effect even if the display pixel cell(s) in the fingerprint collection region 24 will not display any image.

Upon the finger touching the display panel 11, the position information of the finger is obtained. Further, the position information may also trigger a preset application. By triggering the preset application, a control instruction for collecting fingerprint may be also generated. The preset application may include an application which requires a fingerprint authentication. In some embodiments, it may include a social procedure, an online shopping procedure, an online payment procedure and a game procedure, or the like.

For an example, as shown in FIG. 7, the display panel 11 shows nine applications including a first application to a ninth application. When the finger touches an image icon of the fifth application, for example, the fifth application is triggered to turn on.

Assuming that the fifth application is an online payment procedure which requires the fingerprint authentication, upon the fifth application being triggered, a control instruction for collecting fingerprint is also generated such that at least one display pixel cell in the fingerprint collection region 24 is under the fingerprint identification mode. That is, fingerprint information is obtained while the finger touches the image icon of the fifth application to facilitate the use.

FIGS. 8A and 8B are schematic diagrams of a display panel applying another method for fingerprint detection consistent with some embodiments of the present disclosure. As shown, the fingerprint collection region 24 is located in a fixed region of the display panel 11. FIG. 8A shows a condition where no finger touches the display panel. In that case, the display pixel cell of the fingerprint collection region 24 and other regions of the display output region 22 perform an image display simultaneously. Shown in FIG. 8B instead, when a finger touches the fingerprint collection region 24, at least one display pixel cell in the fingerprint collection region 24 is under fingerprint identification mode to obtain the fingerprint information. On the other hand, the display pixel cells in other region of the display output region 22 remain displaying the previous image.

The electronic device provided by the present disclosure includes the disclosed display panel, in which a fixed region or a partial region of the display panel may be configured to display an image and perform fingerprint collection. In some examples, one electrode of each display pixel cell may be configured as a transmitting end of fingerprint collection, and another electrode may be configured as a receiving end of fingerprint collection. Still another electrode may be configured to show a notification message.

In the disclosed method, electronic device, and display panel for fingerprint detection, the at least one display pixel cell of the display panel, corresponding to the fingerprint collection region, may be configured for fingerprint detection, in addition to a display function. The fingerprint information of the finger in the fingerprint collection region may be obtained by the at least one display pixel cell under a fingerprint identification mode. Therefore, there is no need to form holes in the display panel for mounting the fingerprint detection module. The mechanical strength of the display panel can be guaranteed with an easy production and a low cost.

It should be noted that the above descriptions are given as embodiments, and some overlapping parts of these examples may be neglected in descriptions for simplification. The electronic device provided by the present disclosure is configured to implement the disclosed method for fingerprint detection. Although different in scope, the elements of the electronic device are similar to those of the method as claimed.

The foregoing is intended to be a specific embodiment of the disclosure, but the scope of the disclosure is not limited thereto. It will be readily apparent to those skilled in the art within the technical scope of the present disclosure to modify or replace. These modifications or substitutions should be covered within the scope of the present disclosure. Accordingly, the protection scope of the present disclosure should be based on the scope of the claims in the following.

What is claimed is:

1. A method for fingerprint detection, comprising:
obtaining a control instruction for collecting a fingerprint;
executing the control instruction to control at least one display pixel cell of a display panel, corresponding to a fingerprint collection region, to be under a fingerprint identification mode, the fingerprint collection region including a partial region of the display panel; and
obtaining fingerprint information of a finger in the fingerprint collection region by the at least one display pixel cell under the fingerprint identification mode.

2. The method according to claim 1, wherein: the at least one display pixel cell, corresponding to the fingerprint collection region, is controlled to be under the fingerprint identification mode by:
controlling a first pixel electrode of the at least one display pixel cell as a transmitting end of a fingerprint collection, and
controlling a second pixel electrode of the at least one display pixel cell as a receiving end of the fingerprint collection.

3. The method according to claim 2, wherein: obtaining the fingerprint information in the fingerprint collection region by the at least one display pixel cell under the fingerprint identification mode, comprises:
upon driving the display panel to complete displaying an image frame and prior to driving the display panel to start displaying a next image frame, providing a driving signal of a fingerprint scanning to the transmitting end, and performing a fingerprint identification according to a detection signal outputted from the receiving end.

4. The method according to claim 1, wherein: executing the control instruction to control the at least one display pixel cell of the display panel, corresponding to the fingerprint collection region, to be under the fingerprint identification mode, comprises:
obtaining position information of a finger currently on the display panel, the position information indicating the fingerprint collection region;
determining the at least one display pixel cell corresponding to the position information; and
controlling the at least one display pixel cell to be under fingerprint identification mode.

5. The method according to claim 1, wherein: executing the control instruction to control the at least one display pixel cell of the display panel, corresponding to the fingerprint collection region, to be under the fingerprint identification mode, comprises:
controlling the fingerprint collection region to display a notification message, while maintaining currently-displayed content on a region outside the fingerprint collection region, and displaying a position of the fingerprint collection region in the display panel through the notification message; and
controlling the at least one display pixel cell, corresponding to the fingerprint collection region, to be under the fingerprint identification mode.

6. An electronic device, comprising:
a display panel including a plurality of display pixel cells in array;
a control circuit configured to obtain a control instruction for collecting fingerprint, and to execute the control instruction to:
control at least one of the display pixel cells of the display panel, corresponding to a fingerprint collection region, to be under a fingerprint identification mode; and
obtain fingerprint information of a finger in the fingerprint collection region by the at least one display pixel cell under fingerprint identification mode, wherein the fingerprint collection region includes a partial region of the display panel.

7. The electronic device according to claim 6, wherein the control circuit is further configured to control a first pixel electrode of the at least one display pixel cell as a transmitting end of a fingerprint collection, and to control a second pixel electrode of the at least one display pixel cell as a receiving end of the fingerprint collection.

8. The electronic device according to claim 7, wherein:
the control circuit further includes a display driver chip and a fingerprint identification chip; and
upon the display driver chip driving the display panel to complete displaying an image frame and prior to the display driver chip driving the display panel to start displaying a next image frame, the fingerprint identification chip is configured to provide a driving signal of fingerprint scanning to the transmitting end, and perform a fingerprint identification according to a detection signal outputted from the receiving end.

9. The electronic device according to claim 6, wherein: the control circuit is further configured to:
obtain position information of a finger currently on the display panel, the position information indicating the fingerprint collection region;
determine the at least one display pixel cell corresponding to the position information; and
control the at least one display pixel cell to be under fingerprint identification mode.

10. The electronic device according to claim 6, wherein: the control circuit is further configured to:
control the fingerprint collection region to display a notification message while maintaining currently-displayed content on a region outside the fingerprint collection region;
display a position of the fingerprint detection in the display panel through the notification message; and
control the at least one display pixel cell, corresponding to the fingerprint collection region, to be under the fingerprint identification mode.

11. The electronic device according to claim 6, further comprising:
connecting ports, electrically connected to the plurality of display pixel cells, wherein the control circuit is electrically connected to the connecting ports to control the at least one display pixel cell of the display panel.

12. The electronic device according to claim 8, wherein the display panel includes a display output region and a frame region surrounding the display output region, wherein the driver chip and the fingerprint identification chip are disposed in the frame region.

13. A display panel , comprising:
a plurality of display pixel cells, arranged in a display array, wherein the display array includes a display output region; and
connecting ports, electrically connected to: a control circuit and the plurality of display pixel cells, wherein the control circuit, via the connecting ports, provides a fingerprint detection signal to at least one display pixel cell of a fingerprint collection region, such that the at least one display pixel cell is under a fingerprint identification mode, the fingerprint collection region being a partial region of the display output region.

14. The display panel according to claim 13, wherein the at least one display pixel cell comprises a first pixel electrode and a second pixel electrode, the first pixel electrode is controlled by the control circuit as a transmitting end of a fingerprint collection, and the second pixel electrode is controlled by the control circuit as a receiving end of the fingerprint collection.

15. The display panel according to claim 14, wherein:
the plurality of display pixel cells is electrically connected to a display driver chip of the control circuit, and the at least one the display pixel cell is electrically connected to a fingerprint identification chip of the control circuit; and
upon the display driver chip driving the plurality of display pixel cells to complete displaying an image frame and prior the display driver chip driving the plurality of display pixel cells to start displaying a next image frame, the transmitting end is provided with a driving signal from the fingerprint identification chip, and the receiving end outputs a detection signal to the fingerprint identification chip to perform a fingerprint identification.

16. The display panel according to claim 13, wherein the fingerprint collection region is determined by a finger currently touching the display panel, such that the at least one display pixel cell of the fingerprint collection region is under the fingerprint identification mode.

17. The display panel according to claim 13, wherein the fingerprint collection region is a fixed region of the display panel, such that a finger touches the fingerprint collection region to control the at least one display pixel cell of the fingerprint collection region to be under the fingerprint identification mode.
